(19) United States
(12) Patent Application Publication
(10) Pub. No.: US 2021/0059232 A1
(43) Pub. Date: Mar. 4, 2021

(54) FISHING LURE JIG WITH IMPROVED WEED GUARD DEVICE AND METHOD

(71) Applicant: Eric David Supinski, Granby, MA (US)

(72) Inventor: Eric David Supinski, Granby, MA (US)

(21) Appl. No.: 16/867,802

(22) Filed: May 6, 2020

Related U.S. Application Data
(63) Continuation-in-part of application No. 16/554,618, filed on Aug. 29, 2019.

(51) Int. Cl. A01K 83/06; A01K 85/00

(52) U.S. Cl. CPC A01K 83/06; A01K 85/00

(57) ABSTRACT

A fishing lure device and method of use are disclosed. The device may be a jig. The jig may include a head, a hook, a weed guard, and an optional skirt. The weed guard may include a skirt collar or other feature or component which may include a shoulder and may optionally allow for flexion of the skirt collar or of the weed guard. The weed guard may include an elongated element, such as a plastic or metal filament. The weed guard may include a bait retention feature, such as a hook, a barb, or a helix. The weed guard may resist flexion or rotation into an area defined by the hook, such that the combination of the weed guard and bait placed upon it may obstruct weeds from getting caught on the hook, while allowing a predator with sufficient force to become caught on the hook.

### BACKGROUND

The present disclosure relates generally to a fishing lure device and method of use. More particularly, the present disclosure relates to fishing lure jig which includes an improved weed guard, related components, and associated methods of use.

Various types of fishing lures are known in the art. One type of lure is commonly known as a jig, and often includes a head or sinker with a molded in, or otherwise attached, hook. Jigs are commonly used for catching a number of different types of fish, including bass and muskellunge, and are often designed to create a jerky vertical motion, though some variants are not intended to enable easy vertical motion. Jig heads are available in a range of sizes, shapes, and colors, with common designs being at least partially round. Some popular designs of jig heads include flipping jig heads, football jig heads, and grass jig heads. A wide range of sizes is available, with common weights ranging from 1/80^{th} of an ounce to approximately a pound. Hooks also vary in type and shape, color, angle, and material. Depending upon the intended use of the jig, it may include a skirt as well as a skirt collar. The skirt is often made out of silicone or other flexible materials, which may simulate a swimming motion and attract predators.

A common problem with jigs, particularly when fishing with a lure which is intended to be near the bottom of a body of water, river, or stream, is that the lure may encounter weeds, sticks, and other impediments. These impediments may get caught around the looping portion of the hook, causing the lure to have its movement restricted, to no longer effectively simulate prey for predators, and to becoming caught and be difficult to retrieve. Some attempted solutions include using a weed guard, which extends from the jig head generally towards the point of the hook. Such weed guards, however, can often add size to the jig, may separate from the head, and also require placement of bait relatively far away from the point of the hook. This can cause predators to be able to manage to eat the bait while at least partially avoiding the hook.

Current jig lures and methods of use continue to face issues of insufficiently preventing weeds and other materials from getting caught on or around the hook. Current jig lures also continue to face issues with not effectively placing bait for a predator to swallow a hook.

### SUMMARY

The disclosure relates generally to a fishing lure device and method of use. More particularly, the present disclosure relates to fishing lure jig which includes an improved weed guard, related components, and associated methods of use. The improved weed guard device enables a user to effectively reduce the likelihood of the hook becoming caught on weeds or other encumbrances while also enabling location of bait in close proximity to the hook.

1. In one embodiment, a fishing lure includes a head and a hook. The head may be made of various materials known in the art, and in one embodiment may be configured to sink in water, such as where it is made of lead, other metals, plastic, or various hybrid materials.

The hook may have one end connected to the head, while the second end is not in contact with the head, though it may be facing towards the head, and an angle offset away from it, or completely away from it. The fishing lure may include a weed guard member, which may be connected to the head. The weed guard member may be rigidly connected to the head, flexibly connected to the head, along flexion within substantially only one place, flexibly connected to the head so as to along flexion substantially within multiple planes, may be rotatably connected to the head, may be connected by a combination of means, or may be connected by other means known in the art.

The hook may define an at least partially open volume, such as between the main body of the hook, between the two ends of the hook, between the hook and the head, or a combination thereof. In one embodiment, the fishing lure may be configured so that the weed guard can move, rotate, or flex between a relaxed configuration and a tensioned configuration. The weed guard may be configured, or its attachment to the head may be configured, such that the end of the weed guard not connected to the head does not fully enter into the at least partially open volume when the weed guard is in the relaxed configuration. In one embodiment, that end of the weed guard may optionally be able to enter into the open volume when the weed guard is in a tensioned configuration, though it may also be prevented from being able to enter into that volume, such as by limitations in its own flexion, rotation, connection to the head, or by features which prevent such movement, such as by the hook itself.

The weed guard member may be unitary, may be made of multiple components, may be entirely flexible, or may contain at least one flexible component. In one embodiment, the weed guard includes a skirt collar. The skirt collar may be made of a flexible material, such as rubber, silicone, nylon, or other materials known in the art. In another embodiment, the weed guard may include at least one filament. The filament may be made of a flexible material, such as rubber, silicone, nylon, plastic, or other materials known in the art. The filament may also be substantially rigid, such as being a wire which may be made of stainless steel, other metals, resin, and other materials known in the art. In one embodiment, both the skirt collar and the filament may be flexible. The skirt collar may function as a knuckle, creating a pivot point around which the filament may rotate or bend.

In one embodiment, the skirt collar may be at least partially retained by the head by being seated in an opening in the head. The skirt collar may also include a lip, such that a skirt may be retained between the skirt collar and the head.

The skirt collar may include an opening which may enter partially into the skirt collar or may pass entirely through the skirt collar, such as where the skirt collar has a generally cylindrical hole. The filament may be inserted at least partially into the opening in the skirt collar and may be retained by means of frictional resistance, pressure, adhesives, snap fits, press fits, or other means known in the art. The filament may partially seat within the skirt collar, may pass all the way through the skirt collar to the end of the skirt collar, or may pass all the way through the skirt collar and come out the other end of the skirt collar.

The weed guard may also include a bait retention feature. The feature may be a hook-like feature, a harpoon-like feature, or other means of penetrating and/or retaining bait. The feature may be a separate component, or may be part of another described component, such as the skirt collar or the filament. In one embodiment, the bait retention feature may be generally or at least partially helical in structure. Bait may be threaded onto the helix, or the helical feature may be pressed into the bait and retain the bait between gaps in the helix. The bait retention feature may be substantially rigid, such as where it may be a metal or plastic helix, but it may also be flexible, such as where softer materials are used or where the cross-sections of materials are configured to allow flexion. In one embodiment, the bait retention feature is a spring.

In one embodiment, the bait retention feature extends away from the skirt collar and towards the end of the filament which is furthest away from the head. It may extend substantially parallel to the filament, or at an offset angle from it. The filament, the bait retention feature, the skirt collar, or the entire weed guard may extend away from the head at an angle relative to the angle of the hook extending away from the head. This angle may be 30 degrees, 45 degrees, 60 degrees, 90 degrees, any angle between these angles, or a lesser or greater angle as well.

The bait retention feature may also at least partially surround the filament. In one embodiment, where the bait retention feature is a helix, the filament passes through the helix, at least partially along an axis defined by the helix. The filament may be substantially straight, or may be angled, bent, or at least partially curved. In another embodiment, the filament is curved, such that it leaves the skirt collar substantially near the center of the collar or the center of the helix, but curves towards the point of the hook as it extends away from the head.

In an alternate embodiment, where the filament does not extend fully through the skirt collar, a second piece of filament or other elongated component may also be located within the skirt collar, extend from it and away from the filament, or may extend from the head into the skirt collar. An additional elongated component may provide additional strength to the skirt collar, may strengthen its connection to the head, or may create a controlled focal point to flexion of the skirt collar, or reduce such flexion. The second elongated element may be made of the same material as the filament, the same material as the head, or other materials known in the art. In one embodiment, the filament enters into the skirt collar, ends within the skirt collar, and a second piece of filament extends from proximate to the end of the filament and out through the opposing side of the skirt collar.

The fishing lure of the present disclosure may be used in a number of different ways. One method of use includes inserting the filament into the piece of bait, such as by sliding the bait over the filament. The bait is then attached to the bait retention feature, such as by twisting the bait onto the helix or spring. The weed guard and its associated components may be configured such that bait may be selected which, when attached over the weed guard, will resist the bait and the weed guard from being able to enter into the central area or open area defined by the hook. In such a way, the weed guard components and the bait together essentially act as a larger weed guard. The bait will be retained on the fishing lure, while resisting weeds or other encumbrances from catching the hook. When a predator attempts to eat the bait, which is proximal to the hook itself, the predator then may become caught on the hook.

The fishing lure may include a bait retention feature which may be configured to aid in retention of bait on the elongated member or filament. The bait retention member may be configured to flex away from the filament. The bait retention member may be connected to the skirt collar, such as by at least partially threading into it or by extending into or through it without threading. In one embodiment, the bait retention member may be passed through the skirt collar, optionally twisted into position, and then pulled forward so that a piercing feature of the bait retention member may at least partially penetrate into the skirt collar, thus aiding in retain the bait retention member in position.

In one method of use, the bait retention member may be flexed away from the filament so that bait may be inserted onto the filament. The bait retention member may then return to a position where it aids in retention of bait, such as by a hook feature on the bait retention member. In another method of use, the bait retention member may be spaced from the filament so as to allow insertion of bait onto the filament. The bait retention member may then be flexed or bent into position so that it latches onto the bait, aiding in keeping bait on the filament.

The disclosure relates to an improved fishing lure device and method of use, such as through the use of the described invention. The method may include the use of a fishing lure which may include one or more of the features or components described herein. Any number of components or features may be used in conjunction with and incorporated into the weed guard described. Various materials, including metals, plastics, and composites, may be used for the described components and features.

It is to be understood that the above mentioned features and the features yet to be explained hereinafter can be used not only in the respectively mentioned combinations but also in other combinations or alone without departing from the context of the present invention.

### BRIEF DESCRIPTION OF THE DRAWINGS

The invention is now disclosed in detail with reference to exemplary embodiments shown in the accompanying drawings, where:

FIG. 1 shows a front top isometric view of an embodiment of a fishing lure device which includes a weed guard that is known in the art;

FIG. 2 shows a side view of the embodiment of the fishing lure device of FIG. 1;

FIG. 3 shows a side view of an embodiment of the fishing lure device of the present disclosure;

FIG. 4 shows a front top isometric view of the embodiment of the fishing lure device of FIG. 3;

FIG. 5 shows a front top isometric view of the embodiment of the fishing lure device of FIG. 3 with the skirt removed for clarity;

FIG. 6 shows a side cross-sectional view of the embodiment of the fishing lure device of FIG. 5;

FIG. 7 shows a side cross-sectional view of an alternate embodiment of the fishing lure device of the present disclosure;

FIG. 8 shows a front top isometric view of another alternate embodiment of the fishing lure device of the present disclosure;

FIG. 9 shows a left side cross-sectional view of the embodiment of the fishing lure device of FIG. 8;

FIG. 10 shows a right side view of the bait retention feature of the embodiment of the fishing lure device of FIG. 8;

FIG. 11 shows a front top isometric view of an alternate embodiment of the fishing lure device of the present disclosure;

FIG. 12 shows a right side cross-sectional view of the embodiment of the fishing lure device of FIG. 11;

FIG. 13 shows a left top isometric view of the bait retention feature of the embodiment of the fishing lure device of FIG. 11;

FIG. 14 shows a front view of the bait retention feature of the embodiment of the fishing lure device of FIG. 11; and

FIG. 15 shows a side view of an alternated embodiment of the fishing lure device of the present disclosure.

### DETAILED DESCRIPTION

Exemplary embodiments of the disclosure are illustrated in the Figures and are explained in the following description in more detail, wherein identical reference numbers refer to identical, or similar, or functionally identical or similar components.

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features or those previously described are omitted or simplified in order not to obscure the illustrative embodiments.

Various operations may be described as multiple discrete operations, in turn, in a manner that is most helpful in understanding the present invention, however the order of description should not be construed as to imply that these operations are necessarily order dependent. In particular, these operations need not be performed in the order of presentation. In some instances, structures and devices may be shown in block diagram or flow chart form in order to facilitate describing the disclosed subject matter.

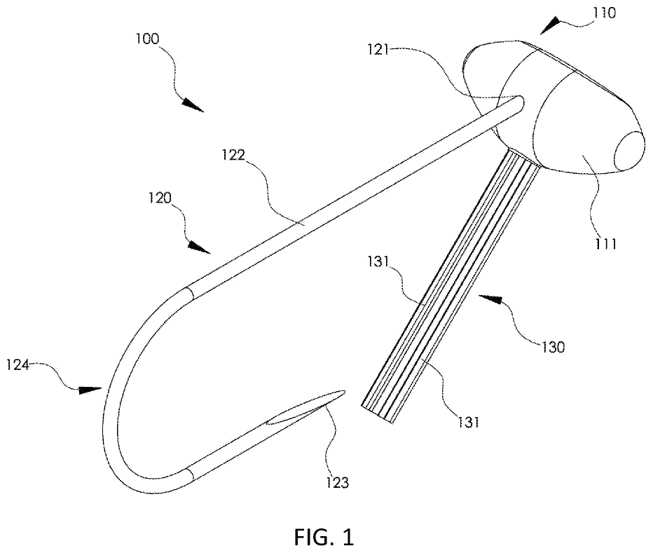

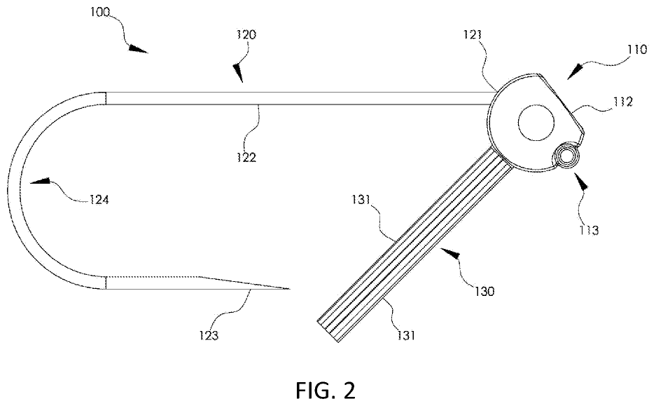

FIGS. 1 & 2 show an embodiment of a fishing lure jig 100 which includes a weed guard 130 such as is known in the art. The jig 100 includes a head 110 which is shown to include curved surfaces 111 and a substantially flat surface 112, though it should be understood that different shapes and surfaces may be used depending on the desired effect on use of the jig 100 by the user. In the embodiment shown, the head 110 is substantially football-shaped, though other shapes may be used, such as substantially spherical, cubic, triangular, pyramidal, mimicking fish or insects, or combinations thereof without deviating from the scope or intent of this disclosure. The head 100 may also include a loop 113 or other feature which may be used for securing a connection means, such as a fishing line, to the jig.

The jig 100 may include a hook 120, which may be connected to the head 110 at a first end 121. The hook 120 may be connected to the head 110 by molding, such as over-molding, welding, adhesives, press fit, snap fit, or other means known in the art. The hook 120 may also be unitary with the head 110. The hook may have an elongated portion 122 which extends substantially away from the head 110 and the first end 121, may include a second end 123, which may optionally be pointed, and may include a curved or loop feature 124. While the second end 123 may be pointed, it may also be blunt, may have an edge or be otherwise sharp, and may include additional features, such as barbs. Though a curved loop feature 124 is shown, the hook 120 may have an angled feature or other bends. It should be understood by those skilled in the art that the second end 123 may be generally directed towards the head 110, such as where the hook 120 curves back approximately 180 degrees, but it may also be offset at a different angle relative to the elongated portion 122, essentially creating a different angle relative to the head 110. Some angles include 30 degrees, 45 degrees, and 60 degrees, though it should be understood that other angles may also be used, both less than, in between, and more than those described.

The embodiment shown includes a weed guard 130 such as those known in the art. The weed guard shown includes a plurality of filaments 131 which are commonly made from flexible or semi-flexible materials, having no retention features and resisting flexion of the weed guard 130 as a whole by reinforcing each filament 131 with multiple additional filaments 131. The weed guard 130 as shown generally resists flexion, does not support bait, and can only flex under significant force.

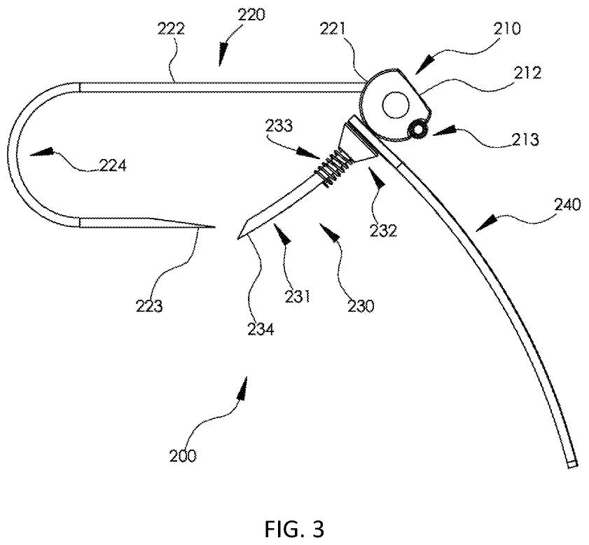

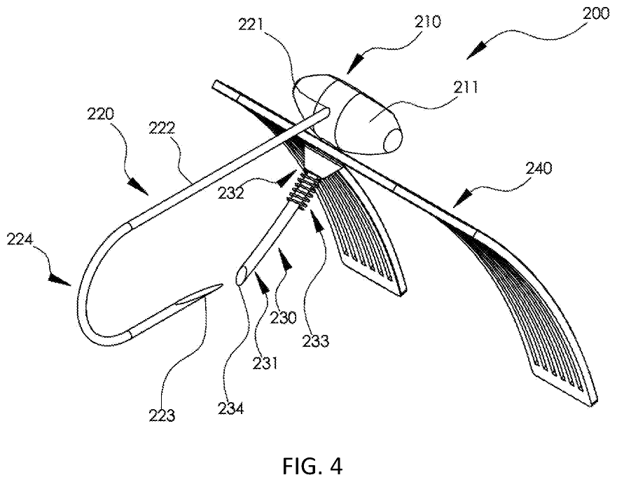

FIGS. 3 & 4 show an embodiment of the fishing lure jig 200 of the present disclosure. The jig 200 includes a head 210, a hook 220, a weed guard 230, and a skirt 240. A loop 213 is shown for connection of fishing line or other connection materials to the head 210, though it should be understood that other connection features may be used without deviating from the scope or intent of this disclosure. It should also be understood that, though the loop 213 is shown on an opposite side of the head 210 from the hook first end 221, the loop 213 may also be located elsewhere, such as closer to the hook 220. The loop 213 may also be located as a feature on the hook 220, or may be entirely absent, such as where fishing line is intended to be tied to the connection point between the hook 220 and the head 210.

The skirt 240 that is shown should be understood to be optionally included, and may also be removable, adjustable, replaceable, may be omitted, or multiple skirts 240 or components which collectively create a skirt 240 may also be used. The skirt 240 is shown in a simplified format, though skirts 240 may also be used which include multiple separate strands of material, smaller groupings of material, may substantially surround the hook 220 or the head 210, and other shapes, sizes, or configurations of skirts 240 may also be used. The skirt 240 is shown made of a flexible material, such as silicone, though other materials which are known in the art may also be used.

The weed guard 230 in the embodiment shown includes an elongated element 231. The elongated element 231 may be partially flexible, substantially flexible, or may be substantially rigid. The elongated element 231 may also be substantially straight, may be at least partially curved, as shown in the present embodiment, or may be bent, angled, or have other shapes. The elongated element 231 may end in a sharp point 234 as shown, though it may also be blunt, have a sharp edge, have barbs, terminate in an enlarged feature, or terminate or connect to other features or components, such as a ball end, without deviating from the scope or intent of the disclosure.

The weed guard 230 is shown as extending from the head 210 of the jig 200 at an angle relative to the elongated portion 222 of the hook 220. The weed guard 230 may extend from the head 210 at a 30 degree, 45 degree, 60 degree, or other angle relative to the hook 220, include angles which are greater, lesser, or in between those described.

In the embodiment shown, the weed guard 230 includes a skirt collar 232. The skirt collar 232 may be connected to the head 210, such as through over-molding, a press fit, a resistance fit, an adhesive, snap fit, or other means known in the art. The skirt collar 232 may be made of a flexible, semi-flexible, rigid, or semi-rigid material, such as rubber. The elongate element 231 may be connected to the skirt collar 232, which is itself connected to the head 210. The skirt collar 232 may be connected to the head 210 rigidly, flexibly, or rotatably, as described above.

The weed guard 230 may also include a bait retention feature 233. The bait retention feature 233 may be connected to the head 210, the elongated element 231, the hook 220, or to the skirt collar 232, as shown. The bait retention feature 233 may be a hook, a barb, an angled or otherwise bent feature, or another feature configured to retain bait or resist bait coming off of the jig 200 when not intended. In the embodiment shown, the bait retention feature 233 is a helical coil, though other shapes and configurations may also be used without deviating from the scope or intent of this disclosure. The bait retention feature 233 may be in line or next to the elongated element 231 or it may, in some configurations, optionally at least partially surround the elongated element 231, such as where the bait retention feature 233 is helical or otherwise is configured to go at least partially around a cross-section of the elongated element 231.

The bait retention feature 233 may be substantially rigid, such as where it is made of a material such as steel or lead, or may be at least partially flexible. In one embodiment, the bait retention feature 233 is a spring, which may be configured to flex, such as along with a flexible elongated element 231, when sufficient force is applied. In one configuration, the bait retention feature 233 and/or the elongated element 231 may resist flexion when the jig 200 encounters weeds or other potential obstructions, but may flex when sufficient force is applied by a fish which has attempted to eat the bait, optionally flexing proximal to the hook 220 or the hook second end 223 or optionally flexing beyond the second end 223, allowing the fish to be caught on the hook 220.

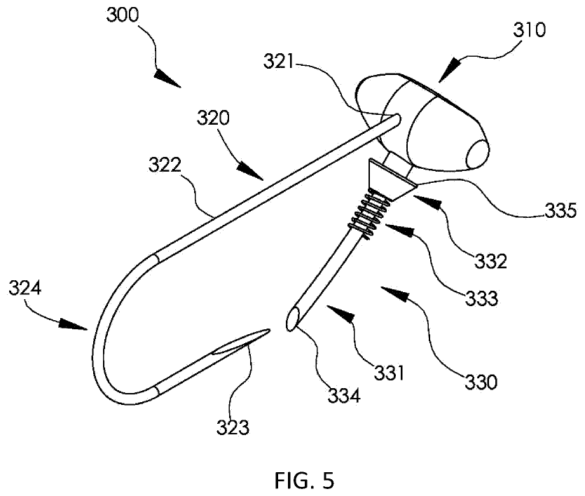

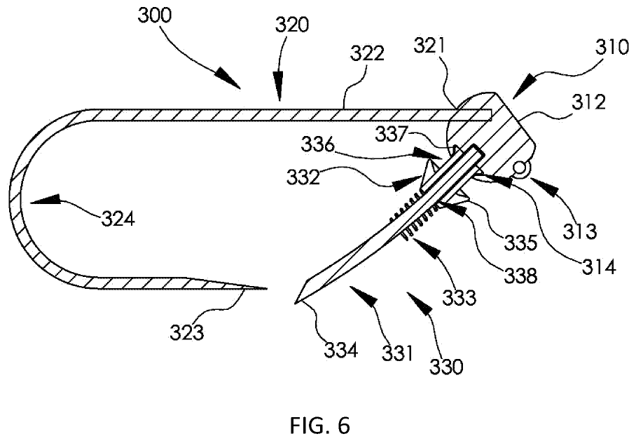

FIG. 5 shows an isometric view of an embodiment of the jig 300 without a skirt 240, both for clarity of view and to emphasize that the skirt 240 is an optional element. FIG. 6 shows a cross-sectional view of the embodiment and configuration of the jig 300 shown in FIG. 5. The skirt collar 332 may include a lip or shoulder 335 which is configured to retain an option skirt 240 between the lip 335 and the head 310, such as within a gap 336 between the lip 335 and the head 310. The lip or shoulder 335 may also function to locate the skirt collar 332 at a maximum depth within an opening 314 within the head 310. Where a gap 336 is present, the shoulder 335 may function to focus flexion of a flexible skirt collar 332 in a desired area, or it may serve to limit flexion when the shoulder 335 comes into contact with a surface of the head 310.

In the embodiment shown, the skirt collar 332 may be inserted into the opening 314 in the head 310. The skirt collar 332 may include a skirt collar retention feature 337, such as a flared out portion, to aid in retaining the skirt collar 332 in the opening 314 in the head 310, though other features, shapes, or adhesives may alternately be used or may be used in conjunction with the retention feature 337.

The elongated element 331 may pass at least partially or into an opening or open area 338 defined by skirt collar 332, such as a recess or channel. In the embodiment shown, the skirt collar 332 includes a channel which passes all the way through the skirt collar 332, through which the elongated element 331 may be inserted. The elongated element 331 may extend substantially through the skirt collar 332, pass partially into it, or may pass entirely through it, as shown. Having the elongated element 331 pass entirely through the skirt collar 332 may strengthen the skirt collar 332 and may strengthen the connection of the skirt collar 332 to the head 310. It may also strengthen the connection of the elongated element 331 to the skirt collar 332 itself, providing more surface area for resistance and friction to counteract forces that may attempt to pull the elongated element 331 from the skirt collar 332 and the head 310, as well as providing more surface area for adhesives.

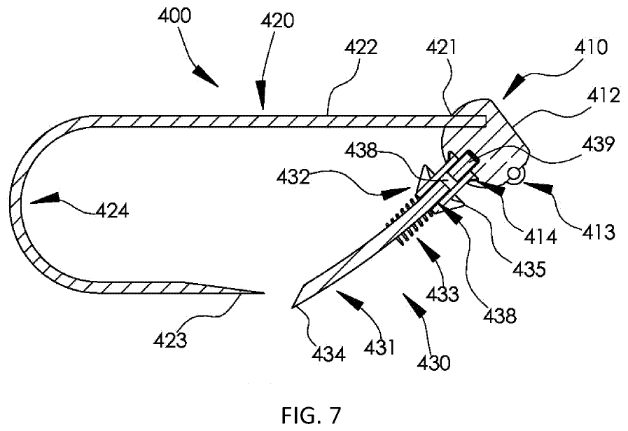

An alternate embodiment of the jig 400 is shown in cross-sectional view in FIG. 7. In the embodiment shown, the elongated element 431 may optionally not pass entirely through the channel 438 in the skirt collar 432. The jig 400 may optionally include a secondary elongated element 439 which may extend at least partially through the channel 438, and may optionally exit through the skirt collar 432 into the head 410. Such a configuration may further focus optional flexion of the skirt collar 432 in a desired area, allowing it to function as a knuckle for controlled flexion. It should be understood, however, that other configurations which do not have the elongated element 431 pass entirely through the skirt collar 432 may also be used without deviating from the scope or intent of this disclosure. In one such embodiment, the head 410 of the jig 400 may include a feature which extends into the opening 414 in the head and at least partially into the channel or other opening 438 of the skirt collar 432, thus further reinforcing the skirt collar 432 and the connection of the skirt collar 432 to the head 410.

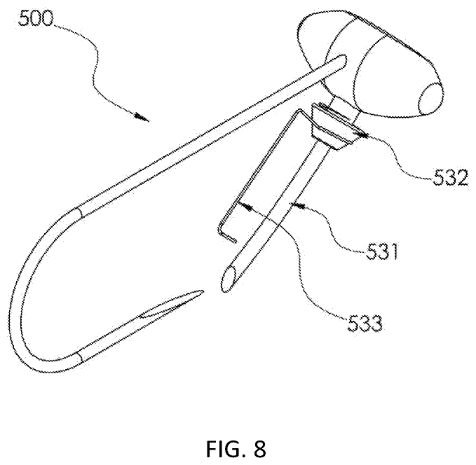

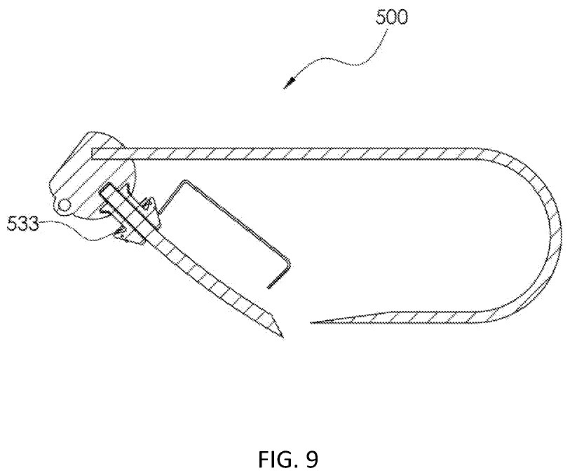

Another alternate embodiment of the fishing lure device 500 is shown in FIGS. 8 and 8, with the skirt 240 removed for clarity. In the embodiment shown, the fishing lure device 500 may include a bait retention feature 533 which may be connected to the skirt collar 532, though it should be understood that the bait retention feature 533 may also be unitary with the skirt collar 532 or may be connected to other components or features of the fishing lure device 500 without deviating from the scope or intent of this disclosure. As shown, the bait retention feature 533 is connected to the skirt collar 532 and may pass at least partially into or through the skirt collar 532. The bait retention feature 533 may be connected to the skirt collar 532 or other components or features of the fishing lure device 500 so as to be able to flex, lever, partially rotate, or bend away from the elongated element 531. The bait retention feature 533 may itself be flexible, elastically deformable, or plastically deformable, may include bendable or deformable sections or components, or the bait retention feature may be substantially rigid while being connected to a flexible or deformable component, such as the skirt collar 532. In one embodiment, the skirt collar 532 may be made at least partially of a deformable or soft material, such as rubber, which will allow the bait retention feature 533 to be flexed away from the elongated element 531 while returning it to substantially close to its original position relative to the elongated element 531 when flexion force is removed or when the bait retention feature 533 is no longer held in place by bait. In another embodiment, the elongated element 531 may itself be flexible or deformable, being bent away from the bait retention feature 533 and then being returned to its original orientation.

In one method of use of the fishing lure device 500, the bait retention feature 533 may be flexed away from the elongated element 531 while bait is being inserted onto the elongated element 531. After bait has been inserted onto the elongated element 531, the bait retention feature 533 may be released, returning to a position where it will aid in retaining bait on the elongated element 531. In an alternate method of use, the bait retention feature 533 may be configured so as to have sufficient space between the bait retention feature 533 and the elongated element 531 to allow bait to be inserted onto the elongated element 531. Once bait has been inserted onto the elongated element 531, the bait retention feature 533 may be bent or flexed so as to impede removal of the bait from the elongated element 531, such as at a hook section 543 of the bait retention feature 533.

Though the bait retention feature 533 is shown located towards the interior of the fishing lure device 500 relative to the elongated element 531 and the skirt collar 532, or above the elongated element 531 as shown, it should be understood that the bait retention feature 533 may be located differently, such as below or to the side of the elongated element 531 or skirt collar 532, in this and all other embodiments described in and anticipated by this disclosure without deviation from the scope or intent of the disclosure.

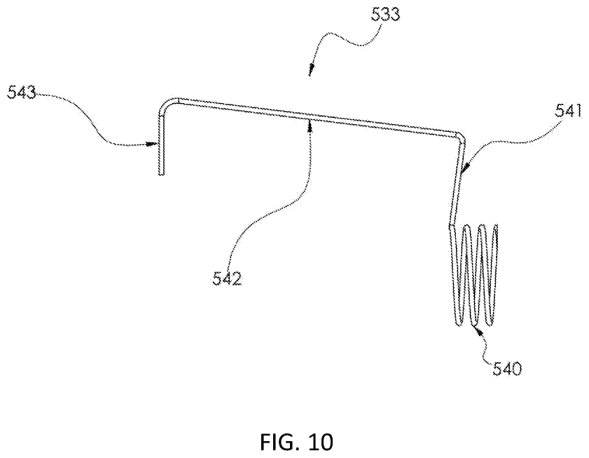

As shown in FIG. 10, the bait retention feature 533 may include an at least partially curved or helical section 540. The helical section 540 may be threaded at least partially into or through the skirt collar 532, may at least partially surround the skirt collar 532, and may at least partially encircle the elongated element 531. The bait retention feature 533 may include a riser section 541 which may allow an elongated section 542 to be distanced away from the elongated element 531.

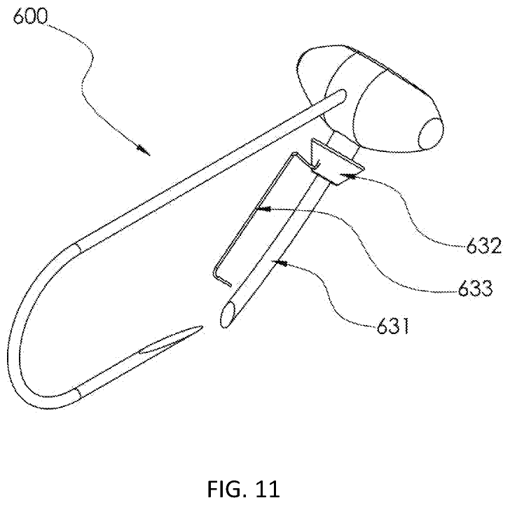

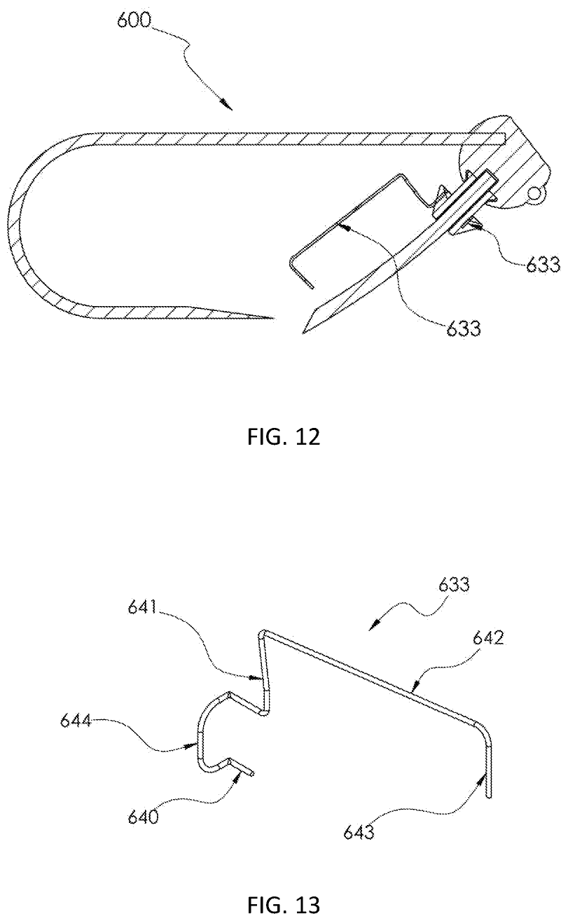

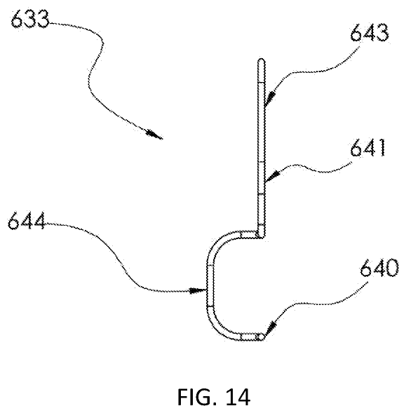

FIGS. 11 and 12 show an alternate embodiment of the fishing lure device 600 with an alternate bait retention feature 633. The bait retention feature 633 may be a bent wire or molded or machined component. The bait retention feature 633 may be pressed into or pressed through the skirt collar 632 or may be passed through or into an opening in the skirt collar 632. As shown in FIGS. 13 and 14, the bait retention feature 633 may include a hook section 643, an elongated section 642, and a riser section 641. In the embodiment shown, the bait retention feature 633 optionally also includes a curved section 644 which may further optionally extend at least partially around or to the side of the elongated element 631. The bait retention feature 633 may also include a piercing feature 640. The piercing feature 640 may be configured to connect to the skirt collar 633, such as by at least partially piercing the skirt collar 633 or by at least partially entering into an opening or recess in the skirt collar 633, aiding in retaining the bait retention feature 633 relative to the skirt collar 633. In other embodiments, the bait retention feature 633 may not include a curved section 644 but may merely offset the piercing feature 640 relative to the riser section 641.

In one embodiment and method of assembly, the bait retention feature 633 may be passed through the skirt collar 632. The bait retention feature 633 may be rotated at least partially around the elongated element 631 on the back side of the skirt collar 632. The bait retention feature 633 may then be pulled forward, so as to press the piercing feature 640 into the skirt collar 632 and retain the position of the bait retention feature 633 relative to the elongated element 631 and the skirt collar 632.

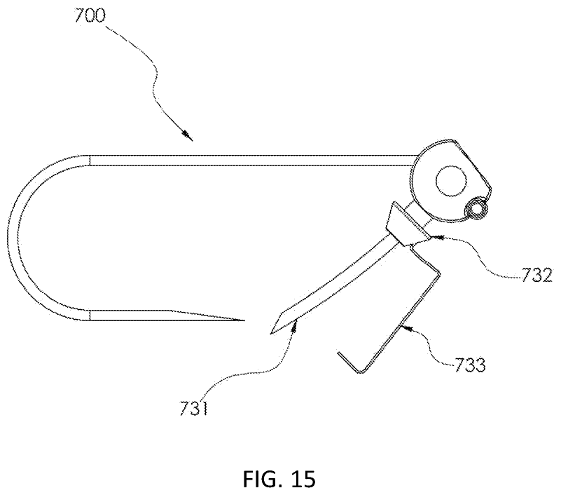

An alternate embodiment of the fishing lure device 700 is shown in FIG. 15. In this embodiment, the bait retention feature 733 is located below or to the outside relative to the skirt collar 732 and the elongated element 731.

While the present invention has been related in terms of the foregoing embodiments, those skilled in the art will recognize that the invention is not limited to the embodiments described. The present invention can be practiced with modification and alteration within the spirit and scope of the appended claims. Thus, the description is to be regarded as illustrative instead of restrictive on the present invention. Accordingly, various modifications, adaptations, combinations, and alternatives may occur to one skilled in the art without departing from the spirit of the invention and scope of the claimed coverage.

What is claimed is:

1. A fishing lure, comprising:
a head;
a hook, comprising a first end connected to the head and a second end that is not in contact with the head; and
a weed guard member connected to the head and comprising a third end and a bait retention feature;
wherein the first end and the second end define an at least partially open volume in between the first end and the second end, the weed guard member defines a first axis which extends away from the head at least partially towards the third end, and further wherein the third end is not within the at least partially open volume when the weed guard member is in a resting configuration.

2. The fishing lure according to claim 1, further wherein the weed guard member comprises at least one flexible component.

3. The fishing lure according to claim 1, further wherein the weed guard member is flexibly connected to the head.

4. The fishing lure according to claim 1, further wherein the third end is at least partially within the at least partially open volume when the weed guard member is in a non-resting configuration.

5. The fishing lure according to claim 1, further wherein the weed guard member comprises a skirt collar which is made of a flexible material.

6. The fishing lure according to claim 5, further comprising a skirt, and further wherein the skirt collar is configured to retain the skirt between a first lip of the skirt collar and an external surface of the head.

7. The fishing lure according to claim 1, further wherein the weed guard member comprises a skirt collar and a flexible filament which is at least partially enclosed by a second at least partially open volume defined by the skirt collar.

8. The fishing lure according to claim 5, further wherein the bait retention feature passes at least partially through the skirt collar.

9. The fishing lure according to claim 8, further wherein the bait retention feature comprises a hook end distal from the skirt collar and configure to aid in retention of bait on the weed guard member.

10. The fishing lure according to claim 8, further wherein the bait retention feature comprises an at least partially helical feature which connects to the skirt collar.

11. The fishing lure according to claim 10, further wherein the at least partially helical feature is threaded into the skirt collar.

12. The fishing lure according to claim 8, further wherein the bait retention feature comprises a piercing feature.

13. The fishing lure according to claim 12, further wherein the bait retention feature passes at least partially through the skirt collar and further wherein the piercing feature is at least partially inserted within an at least partially open skirt collar volume.

14. The fishing lure according to claim 8, further wherein the bait retention feature is configured to be bent or flexed away from the first axis when bait is being inserted onto the weed guard member.

15. The fishing lure according to claim 8, further wherein the bait retention feature is configured to be bent or flexed towards the first axis after bait has been inserted onto the weed guard member.

16. The fishing lure according to claim 8, further wherein the bait retention feature is a metal wire.

17. The fishing lure according to claim 8, further wherein the bait retention feature is at least partially made of plastic.

18. A method of using a fishing lure, comprising:
attaching a piece of bait over an elongated member component of a weed guard member; and
attaching the piece of bait onto the elongated member component of the weed guard member;
wherein the fishing lure comprises a head, a hook rigidly connected to the head, and a weed guard member, and further wherein the weed guard member further comprises a flexible skirt collar and the elongated member is flexible and is connected to the flexible skirt collar, and the weed guard member is configured to resist weeds from entering into an at least partially open volume defined by the hook when the bait is attached to the elongated member, and further wherein the weed guard member further comprises a bait retention feature configured to aid in retaining bait on the elongated member.

19. The method of using a fishing lure according to claim 18, further wherein the bait retention member is flexed away from the elongated member when bait is being inserted onto the elongated member.

20. The method of using a fishing lure according to claim 18, further wherein the bait retention member is flexed towards the elongated member after bait has been inserted onto the elongated member, and further wherein the bait retention member further comprises a hook feature configured to aid in retaining bait on the elongated member.
